(19) United States
(12) Patent Application Publication
(10) Pub. No.: US 2023/0101185 A1
(43) Pub. Date: Mar. 30, 2023

(54) DIFFERENTIAL TASK ALLOCATION SYSTEMS AND METHODS FOR ITEM HANDLING FACILITIES

(71) Applicant: ZEBRA TECHNOLOGIES CORPORATION, Lincolnshire, IL (US)

(72) Inventor: Yuri Astvatsaturov, Lake Forest, IL (US)

(21) Appl. No.: 17/488,159

(22) Filed: Sep. 28, 2021

(51) Int. Cl. G05B 19/418; H04W 4/029

(52) U.S. Cl. CPC G05B 19/41865; G05B 19/41895; H04W 4/029; G05B 2219/25387; G05B 2219/25231

(57) ABSTRACT

A system includes: a location tracking subsystem in a facility containing support structures supporting items; a plurality of mobile computing devices associated with respective users; and a plurality of autonomous transporters to transport items transferred by users from the support structures, and/or transport items to the support structures for transfer thereto by users. User profiles contain, for each user, a physical activity metric and a physical activity target. The system includes a server to: obtain, from the location tracking subsystem, transporter and mobile device locations; obtain a task defining a task location, and an identifier of an item for transfer to or from a support structure at the task location; select a transporter, according to the task and transporter locations; select a mobile device, according to the task and mobile device locations, the physical activity metrics and targets; and allocate the task to the selected transporter and mobile device.

### BACKGROUND

Tasks in a facility such as a warehouse may include retrieving an item from a shelf for packing, shipping, etc., or placing an item received at the warehouse on a shelf for storage. A given task may involve actions performed by multiple entities within the facility. The allocation of a task to multiple entities, to coordinate the movements of those entities within the facility, may lead to ineffective use of some or all of those entities.

### SUMMARY

In an embodiment, the present invention is a task allocation system, comprising: a location tracking subsystem disposed in a facility, the facility containing a plurality of support structures, each support structure supporting items, the items having respective item identifiers; a plurality of mobile computing devices, each of the plurality of mobile computing devices associated with a respective user in the facility; a plurality of autonomous transporters deployed in the facility to at least one of (i) transport an item transferred by the user from one of the plurality of support structures, or (ii) transport the item to one of the plurality of the support structures to be transferred by the user thereto, the location tracking subsystem operable to obtain location data associated with each of the plurality of mobile computing devices and each of the plurality of autonomous transporters; a user profile repository containing, for each of the users, a record defining (i) a physical activity metric, and (ii) a physical activity target; and a server configured to: obtain, from the location tracking subsystem, respective locations for each of the plurality of transporters and each of the plurality of mobile computing devices; obtain a task definition containing (i) a task location, and (ii) an item identifier corresponding to an item to be transferred to or from one of the plurality of support structures at the task location; select one of the plurality of transporters, according to the obtained transporter locations and the task location; select one of the mobile computing devices, according to the obtained mobile computing device locations, the task location, the physical activity metrics, and the physical activity targets; and allocate the task definition to the selected one of the transporters and the selected one of the mobile computing devices.

In another embodiment, the present invention is a method, comprising: obtaining, from a location tracking subsystem disposed in a facility, the facility containing a plurality of support structures, each support structure supporting items, the items having respective item identifiers, respective locations for each of a plurality of transporters and each of a plurality of mobile computing devices, wherein (a) each of the plurality of mobile computing devices is associated with a respective user in the facility, and (b) each of the plurality of autonomous transporters is deployed in the facility to at least one of (i) transport an item transferred by the user from one of the plurality of support structures, or (ii) transport the item to one of the plurality of the support structures to be transferred by the user thereto; obtaining a task definition containing (i) a task location, and (ii) an item identifier corresponding to an item to be transferred to or from one of the plurality of support structures at the task location; select one of the plurality of transporters, according to the obtained transporter locations and the task location; selecting one of the mobile computing devices, according to the obtained mobile computing device locations, the task location, physical activity metrics for each of the users, and physical activity targets for each of the users, wherein the physical activity metrics and the physical activity targets are stored in a user profile repository; and allocating the task definition to the selected one of the transporters and the selected one of the mobile computing devices.

In a further embodiment, the present invention is a task allocation system, comprising: a location tracking subsystem disposed in a facility, the facility containing a plurality of support structures, each support structure supporting items, the items having respective item identifiers; a mobile computing device associated with a user in the facility; an autonomous transporter deployed in the facility to at least one of (i) transport an item transferred by the user from one of the plurality of support structures, or (ii) transport the item to one of the plurality of the support structures to be transferred by the user thereto, the location tracking subsystem operable to obtain location data associated with the mobile computing device and the autonomous transporter; a user profile repository containing, for the user, a record defining (i) a physical activity metric, and (ii) a physical activity target; and a server configured to: obtain, from the location tracking subsystem, respective locations for the transporter and the mobile computing device; obtain a task definition containing (i) a task location, and (ii) an item identifier corresponding to an item to be transferred to or from one of the plurality of support structures at the task location; allocate the task definition to the transporter according to the obtained transporter location and the task location; and allocate the task definition to the mobile computing device, according to the obtained mobile computing device location, the task location, the physical activity metric, and the physical activity target.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a facility containing a task allocation system.

FIG. 2 is a flowchart of a task allocation method.

FIG. 3 is a diagram illustrating an example performance of blocks 205 and 210 of the method of FIG. 2.

FIG. 4 is a diagram illustrating an example performance of block 215 of the method of FIG. 2.

FIG. 5 is a diagram illustrating an example performance of blocks 230 and 235 of the method of FIG. 2.

FIG. 6 is a diagram illustrating another example performance of blocks 230 and 235 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

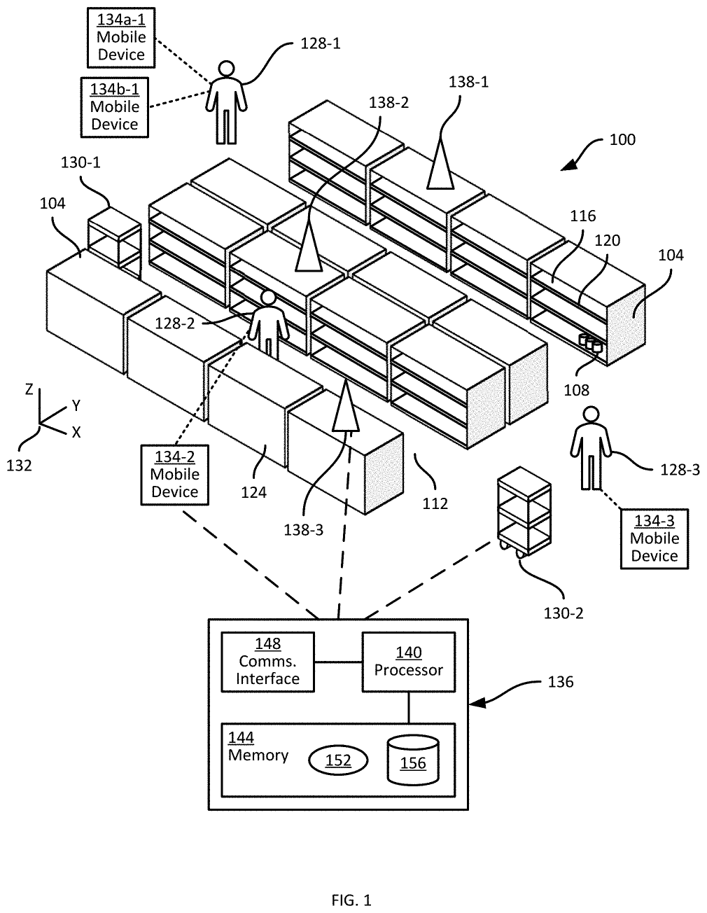

FIG. 1 illustrates a task allocation system 100 deployed in an interior of a facility, such as a warehouse, a manufacturing facility, or the like. The facility includes a plurality of support structures 104 carrying items 108. In the illustrated example, the support structures 104 include shelf modules, e.g., arranged in sets forming aisles 112. FIG. 1, specifically, illustrates two aisles 112 each formed by eight modules 104. The facility can have a wide variety of layouts other than the example layout shown in FIG. 1.

The support structures 104 can include shelves, pegboards, bins, and the like, to support the items 108 thereon. As shown in FIG. 1, for example, a particular module 104 is illustrated as having support surfaces 116 terminating in shelf edges 120, which face into the corresponding aisle 112. A shelf edge 120, as will be apparent to those skilled in the art, is a surface bounded by adjacent surfaces having different angles of inclination. In the example illustrated in FIG. 1, each shelf edge 120 is at an angle of about ninety degrees relative to the corresponding support surface 116 above that shelf edge 120 and the underside (not shown) of the support surface 116. In other examples, the angles between a shelf edge 120 and adjacent surfaces is more or less than ninety degrees.

As seen in FIG. 1, the support surfaces 116 are accessible from the aisles 112 into which the shelf edges 120 face. In some examples, each module has a back wall 124 rendering the support surfaces 116 inaccessible from the opposite side of the module. In other examples, however, the support structures 104 can be open from both sides (e.g., the back wall 124 can be omitted).

The support surfaces 116 carry the items 108, which can include any of a wide variety of objects, such as products, packages, and the like. The items 108 may be received at the facility and placed on the support structures 104 for storage. Later, the items 108 may be retrieved from the support structures 104, e.g., for consumption in a manufacturing process, for shipment from the facility, or the like. The task allocation system 100, in general, enables the placement of the items 108 onto the support structures 104 and the retrieval of items 108 from the support structures 104.

Placement of the items 108 onto the support structures 104, as well as retrieval of the items 108 from the support structures 104, may be accomplished by workers 128, also referred to as users 128. Three users 128-1, 128-2, and 128-3 are shown in FIG. 1, but it is contemplated that the number of users 128 deployed in the facility may vary over time, and may be dependent on the size of the facility, the nature of the items 108, and the like. Transportation of the items 108 between the support structures 104 and other portions of the facility, such as shipping areas for outbound items 108, receiving areas for inbound items 108, and the like, may be implemented using certain components of the system 100, rather than such transportation being performed solely by the users 128.

In particular, the system 100 includes a plurality of autonomous transporters 130. FIG. 1 includes two example transporters 130-1, and 130-2, although it will be understood that greater numbers of transporters 130 can be employed in other implementations, for example based on the size and/or layout of the facility. The transporters 130, which may also be referred to as collaborative robots or “cobots”, each include a movable chassis, e.g., with a locomotive assembly such as wheels, tracks or the like driven by an electric motor. The chassis supports one or more bins, shelves or the like, configured to hold items 108. Each transporter 130 also includes navigational components enabling semi-autonomous or autonomous navigation within the facility.

To transport an item 108 to a support structure 104, the item 108 may be placed on a transporter 130, and the transporter 130 may be instructed to travel to the relevant support structure 104. A user 128 may also be instructed to travel to that support structure, and to remove the item 108 from the transporter 130, and place the item 108 on the support structure 104. Conversely, to transport an item 108 from a support structure 104, e.g., to ship the item 108 from the facility to another facility, a customer, or the like, a transporter 130 and a user 128 may be instructed to travel to the support structure 104 carrying the relevant item 108. The user 128 may then transfer the item 108 from the support structure 104 to the transporter 130. The transporter 130 may then transport the item 108 to another location in the facility, such as a shipping area. As will be apparent, each transporter 130 can be configured to carry a plurality of items 108 simultaneously, such items 108 having been transferred to the transporter 130 from the support structures 104 by various different users 128. The items 108 carried by a transporter 130 can also be intended for transfer to various distinct support structures 104 by different users 128. In other words, users 128 and transporters 130 are not paired persistently. Instead, a user 128 and a transporter 130 may be paired for a given task (e.g., to transfer a particular item 108 from a support structure 104 to the transporter 130), and each of the user 128 and the transporter 130 may subsequently be paired with other transporters 130 or users 128 for the completion of other tasks.

The above pairings are implemented by providing instructions to the users 128 and the transporters 130. Each instruction, also referred to as a task, may specify a particular location in the facility, such as an aisle identifier and/or module identifier, coordinates in a facility coordinate system 132, or the like. The task may also specify an identifier of a particular item 108, such as a universal product code, item name, or the like.

To provide the above instructions to the users 128, the system 100 includes mobile computing devices 134 associated with the users 128. Thus, in the illustrated example, the system 100 includes devices 134-1, 134-2, 134-3. Each device 134 can be a tablet computer, a smart phone, a wearable computer (e.g., smart glasses), or the like. In some examples, a user 128 can be equipped with distinct mobile devices, physically separate but both carried by the user 128, and in some examples intercommunicating with each other. For example, the user 128-1 is illustrated as being equipped with a first mobile device 134a-1, and a second mobile device 134b-1. For example, the device 134a-1 can be a smart watch, a heads-up display, or the like, while the device 134b-1 can include a smartphone, a tablet computer, or the like. In examples in which a user 128 is equipped with distinct mobile devices, the devices may be referred to collectively as a mobile device 134. When a device 134 receives and displays or otherwise presents a task to the corresponding user 128, the user 128 can navigate to the location specified by the task.

The transporters 130 can include communication interfaces (e.g., WiFi interfaces or the like) enabling the transporters 130 to receive messages containing task information. Upon receiving a task, a transporter 130 can be configured to autonomously navigate to the location specified in the task. The transporter 130 may therefore include various navigational components, including motion sensors (e.g., odometry components), image sensors, and the like, enabling the transporters 130 to track their locations in the facility, as well as generate and execute paths through the facility.

The system 100 further includes a server 136 configured to allocate tasks to the users 128 (via the mobile devices 134) and to the transporters 130. For example, the server 136 is configured to select, for each task, one mobile device 134 and one transporter 130, and to instruct the selected mobile device 134 and transporter 130 to perform the task. To select transporters 130 and mobile devices 134 for task allocations, the server 136 is configured to obtain locations of the transporters 130 and the mobile devices 134, in the coordinate system 132. For example, the system 100 can include a location tracking subsystem enabling periodic retrieval of device 134 and transporter 130 locations by the server 136. The location tracking subsystem can include, for example, wireless emitters 138 deployed throughout the facility, such as wireless network access points, beacons (e.g., Bluetooth beacons), radio frequency identification (RFID) readers, and the like. In other examples, the location tracking subsystem can include cameras or other sensors configured to detect the devices 134 and/or transporters 130, e.g., from video streams captured by the cameras. The devices 134 and the transporters 130 can be configured to determine their locations in the coordinate system 132 based on signal strength measurements and/or other parameters determined from signals generated by the emitters 138. The devices 134 and the transporters 130 can then report the determined locations to the server 136. In other examples, the emitters 138 can cooperate to determine and report the locations of transporters 130 and/or devices 134 to the server (e.g., in the case of emitters 138 that include RFID readers).

To select a transporter 130 for a given task, the server 136 is configured to compare transporter 130 locations with task locations, and to assign tasks to transporters 130 to minimize either or both of travel time (i.e., time spent travelling to a task location) and idle time (i.e., time spent waiting at a task location for completion of a task, or for assignment of another task) for the transporters 130. That is, the allocation of tasks to transporters 130 may prioritize the completion of the greatest number of individual tasks for each transporter 130 in a given time period.

Allocating tasks to the devices 134 in the same manner as described above in connection with the transporters 130, however, may result in suboptimal deployment of the users 128 associated with the devices 134. For example, allocating tasks to users 128 (via the devices 134) so as to minimize either or both of travel time and idle time may result in the users 128 travelling relatively small distances within the facility over the course of an average shift, or other suitable period. The physical fitness of users 128 may therefore suffer over time, in part from the lack of travel distance. Further, increasing the proportion of a shift, work day or the like of a user 128 that is consumed by transferring items 108 between the support structures 104 and the transporters 130 may increase the likelihood of injury from lifting and manipulating the items 108.

The server 136 is therefore configured to allocate tasks differentially to the transporters 130 and the users 128. In particular, while the server 136 is configured to allocate tasks to the transporters 130 to minimize travel time and/or idle time, the server 136 is configured to allocate tasks to the users 128 based at least in part on physical activity metrics, and corresponding physical activity targets. Thus, the server 136 can dynamically pair a transporter 130 and a user 128 for a given task based on different sets of factors. As a result, the server 136 can optimize task allocation to prioritize task completions for the transporters 130 (i.e., minimizing idle time and/or transit time), and to prioritize physical fitness for the users 128. As will be apparent, prioritizing physical fitness for the users 128 may reduce the number of tasks completed by a given user 128 over a relatively short timeframe (e.g., a shift, a week, or the like), but may increase the number of tasks completed by that user 128 over a longer timeframe (e.g., a month, a year, etc.) by reducing the likelihood of injury, improving user fitness, or the like. In other words, by implementing differential task allocation between the transporters 130 and the users 128, the system 100 may improve the effectiveness with which the facility's resources are deployed.

FIG. 1 also illustrates certain internal components of the server 136. The server 136 includes a special-purpose controller, such as a processor 140, interconnected with a non-transitory computer readable storage medium, such as a memory 144. The memory 144 includes a combination of volatile memory (e.g., Random Access Memory or RAM) and non-volatile memory (e.g., read only memory or ROM, Electrically Erasable Programmable Read Only Memory or EEPROM, flash memory). The processor 140 and the memory 144 each comprise one or more integrated circuits.

The server 136 also includes a communications interface 148 interconnected with the processor 140. The communications interface 148 includes any suitable hardware (e.g., transmitters, receivers, network interface controllers and the like) allowing the server 136 to communicate with other computing devices (e.g., the devices 134 and the transporters 130) via a suitable combination of local and/or wide-area networks. The specific components of the communications interface 148 are selected based on the type(s) of network(s) used by the server 136.

The memory 144 stores computer readable instructions for execution by the processor 140. In particular, the memory 144 stores a task allocation application 152 (also referred to simply as the application 168) which, when executed by the processor 140, configures the processor 140 to allocate tasks to ad-hoc pairs of transporters 130 and devices 134 based on the factors mentioned above. The application 152 may also be implemented as a suite of distinct applications in other examples. Those skilled in the art will appreciate that the functionality implemented by the processor 140 via the execution of the application 152 may also be implemented by one or more specially designed hardware and firmware components, such as FPGAs, ASICs and the like in other embodiments.

The system 100 also includes a user profile repository 156 accessible to the server 136. In the present example, the repository 156 is stored in the memory 144, although in other examples the repository 156 can be stored separately from the server 136 and accessed by the server 136 using the communications interface 148. The repository 156 contains, for each user 128 in at least a subset of the users 128, a physical activity target. The physical activity target can include any one or more of a step count, a travel distance target (e.g., representing a target distance for the user 128 to travel in the facility over a given time period, such as a day, a week, or the like), a calorie burn target, and the like. The repository 156 can also contain a physical activity metric. In general, the target represents a health-related goal of the user 128 for a given time period, and the metric represents current progress towards that goal. The server 136 can be configured to employ the targets and metrics, when allocating tasks to the users 128, to reduce differences between the physical activity metrics and the physical activity targets.

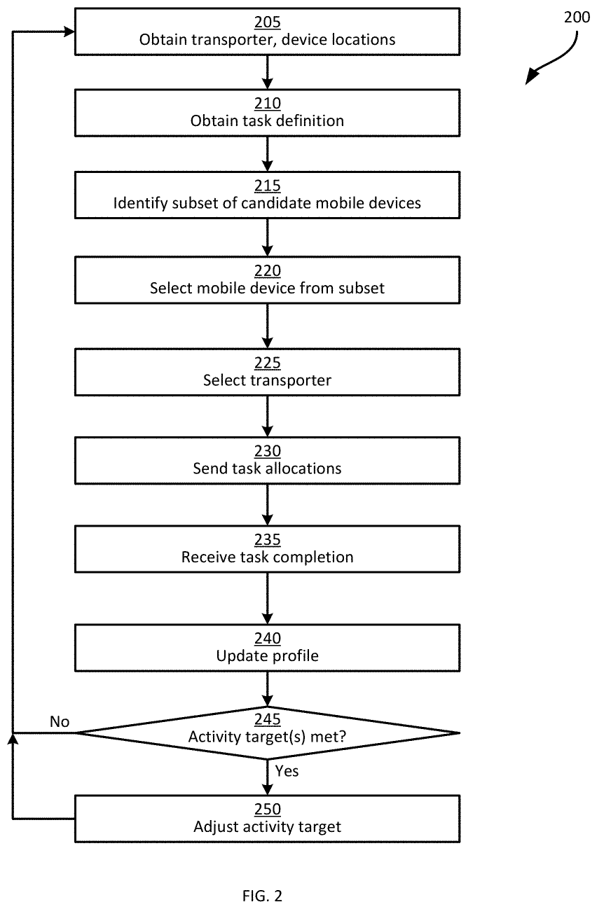

Turning to FIG. 2, a method 200 of task allocation is shown. The method 200 will be discussed below in conjunction with its performance in the system 100, to allocate tasks to selected pairs of the transporters 130 and the users 128 (via the corresponding devices 134). In the discussion below, the method 200 is performed by the server 136, via execution of the application 152 by the processor 140.

At block 205, the server 136 is configured to obtain the locations of each of the transporters 130 and the locations of each of the devices 134. The performance of block 205 can be repeated periodically throughout the performance of the method 200, at any suitable frequency. In some examples, the location of each transporter 130 and/or device 134 can be obtained about once every fifteen seconds. In other examples, the server 136 can obtain locations at higher or smaller frequencies, or at variable frequencies. As noted earlier, various mechanisms can be employed by the server 136 to obtain the locations. For example, each transporter 130 and each device 134 can be configured to determine its own location (e.g., by processing signals from the emitters 138), and report the location to the server 136. In other examples, the server 136 can determine locations for transporters 130 and/or devices 134 based on data collected from the emitters 138.

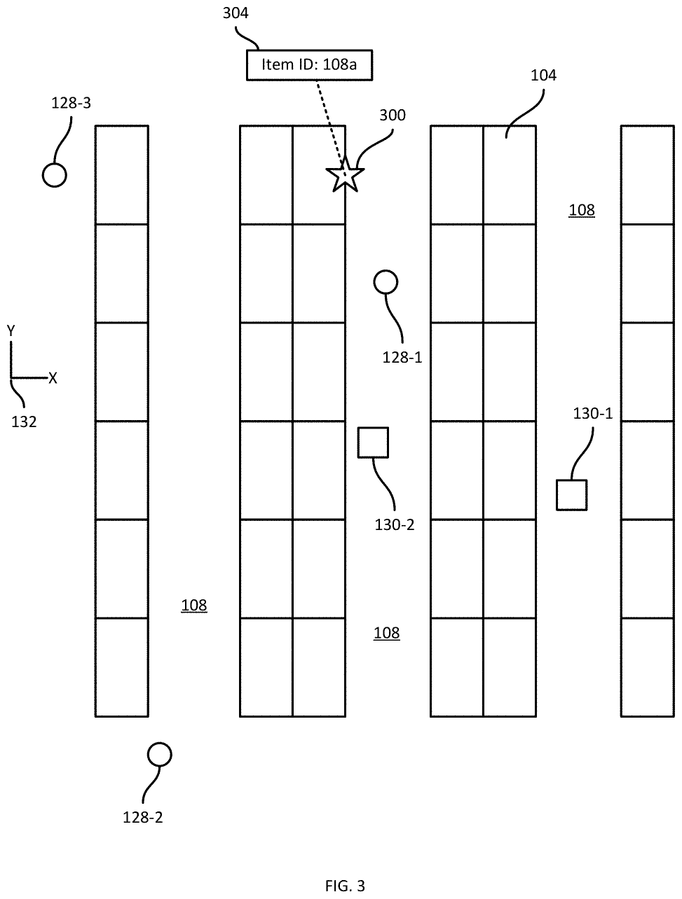

Turning to FIG. 3, an overhead view of the facility is shown, with locations of the devices 134 and the transporters 130 as obtained at block 205 illustrated thereon. The locations obtained at block 205 are defined in the coordinate system 132.

Referring again to FIG. 2, at block 210, the server 136 is configured to obtain a task definition. The task definition can be generated locally at the server 136, or received from another computing device connected to the system 100. In general, the task definition represents an instruction to transfer a particular item 108 from a support structure 104 or to a support structure 104. Thus, some task definitions represent the transfer of an item 108 from a support structure 104 to a transporter 130 (e.g., by a user 128), for subsequent transportation to another portion of the facility. Other task definitions represent the transfer of an item 108 from a transporter 130 to a support structure 104 by a user 128. The item 108 may have previously been placed on the transporter 130 at a receiving dock or other suitable area of the facility.

The actual generation of the task definition is beyond the scope of the present disclosure. The task definition obtained by the server 136 at block 210 includes at least a location in the facility, and an item identifier. The location can be specified in either or both of coordinates in the system 132, and aisle/module identifiers. The item identifier can include a universal product code (UPC), an item name, or the like. The task definition can also include various other information in some examples, such as an item count (e.g., if the task is to transfer more than one of the relevant item between a support structure 104 and a transporter 130). Turning briefly again to FIG. 3, a task definition is illustrated as including a task location 300, and an item identifier 304.

Having received the locations of the devices 134 and the transporters 130, as well as the task definition, the server 136 can then allocate the task represented by the task definition to a pair of a transporter 130 and a user 128. Specifically, at block 215 the server 136 is configured to select a subset of candidate devices 134 for task allocation. The subset selected at block 220, in general, includes those devices 134 that are sufficiently close to the task location 300 to enable completion of the task within a configurable threshold time period. For instance, the server 136 can store a threshold time within which any task is expected to be completed (e.g., five minutes). In other examples, the server 136 can store a threshold distance, representing the distance an average user 128 can travel within the above-mentioned expected time.

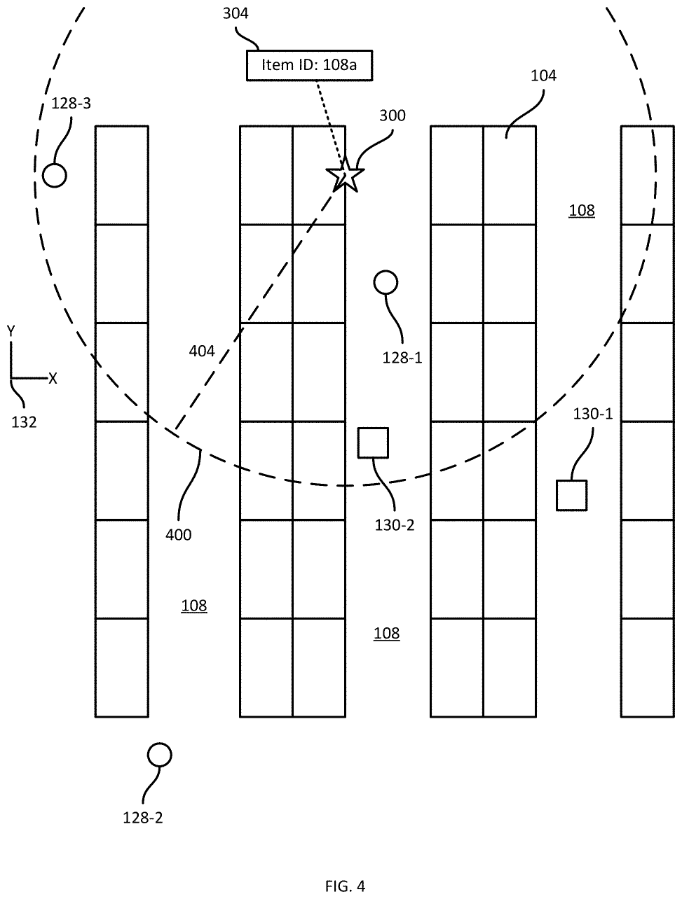

Referring to FIG. 4, an area 400 centered on the task location 300 has a radius 404. Devices 134 that are within the radius 404 of the task location 300 may be assumed to be close enough to the task location 300 to be candidates for task allocation. Devices 134 further from the task location 300 than the radius 404, however, may be assumed to be too distant from the task location 300. Thus, in the illustrated example, the users 128-1 and 128-3 (or more specifically, their corresponding devices 134-1 and 134-3) are selected at block 215. The user 128-2, in other words, is not eligible for allocation of the task defined by the location 300 and item identifier 304.

In other examples, the server 136 can make the selection at block 215 based on user profile data from the repository 156. For example, the repository 156 can contain average walking speeds specific to each user 128, and the server 136 can therefore generate, for each user 128, a radius equivalent to the radius 404 in determining whether to include the user 128 in the subset. In further examples, the repository 156 can include additional operational constraints for one or more of the users 128. For instance, the repository 156 can specify one or more of a maximum handling weight for a given user 128, which the server 136 can compare to a stored weight of the item identified in the task definition. If the item weight exceeds the maximum handling weight of a given user 128, then that user 128 is not included in the subset selected at block 215, irrespective of proximity to the task location 300. Various other constraints will also occur to those skilled in the art. In further examples, a user profile can include a constraint indicating that the physical activity target for that user 128 should not be exceeded. The system 100 can be configured, for users 128 without such a constraint, to allocate tasks so as to enable those users 128 to meet or exceed their respective targets. For users 128 with such a constraint (e.g., because the user 128 is recovering from injury, or the like), however, the server 136 may omit such users 128 from the subset at block 215 if the distance between the task location 300 and the user location is likely to result in the user exceeding their target if allocated the task.

Returning to FIG. 2, at block 220 the server 136 is configured to select one candidate device 134 (and thus, the corresponding user 128) from the subset selected at block 215. The selection of a candidate device 134 is based on the locations (from block 205) of the devices 134 in the subset from block 215, as well as on the task location 300. Further, the selection at block 220 is based on the physical activity targets, and physical activity metrics, stored in the repository 156. Table 1 illustrates an example repository 156.

TABLE 1
Example Repository 156

| User ID | Device ID | Activity Target | Activity Metric |
|---|---|---|---|
| 128-1 | 134-1 | 5000 steps/day | 1400 steps |
| 128-2 | 134-2 | 2500 Cal./day | 1200 Cal. |
| 128-3 | 134-3 | 9000 steps/day | 2000 steps |

As seen above, each user 128 has a physical activity target, e.g., shown in steps per day for the users 128-1 and 128-3, and in calories burned per day for the user 128-2. The targets, in other words, need not be defined in the same units for all users 128. In some examples, the server 136 can receive targets in various units or formats, and convert the targets to a common format or unit for use in the method 200. For example, all activity targets can be converted to a distance travelled per common time period (e.g., one day).

Each user 128 also has an activity metric stored in the repository 156. The activity metric represents the current progress of the user 128 towards the target. Thus, for example, the repository 156 as shown above indicates that the user 128-1 has traveled one thousand four hundred steps in the current day, towards a target of five thousand steps.

The server 136, to allocate a task to a user 128 at block 220, is configured to execute an optimization process to reduce a difference between the physical activity metrics and the physical activity targets stored in the repository 156. The optimization process seeks to minimize the differences between metrics and targets for as many users 128 as possible. Thus, for example, when a single task is to be allocated, the server 136 may select the user 128 with the greatest difference between the metric and the target (that is, the greatest shortfall from metric to target, e.g., as a proportion of the target). When multiple tasks are to be allocated simultaneously (e.g., at block 210, the server 136 may receive a set of tasks to be allocated among the devices 134 and the transporters 130), the server 136 can allocate the tasks among the subset of users 128 to minimize the sum of the differences between metrics and targets. Various other optimization processes will also occur to those skilled in the art.

Referring again to FIG. 4, in the present example performance of block 220, the server 136 selects the user 128-3 (i.e., the device 134-3), as the difference between the metric and the target of the user 128-3 is greater than for the user 128-1. In particular, the difference is about 78% of the target for the user 128-3, and 72% for the user 128-1. In other examples, the server 136 need not compare differences between metrics and targets for multiple users 128. More generally, at block 220 the server 136 selects a user 128 and corresponding device 134 to reduce the difference between the metric and the target for the selected user 128. In some examples, in which the server 136 performs the method 200 for a plurality of tasks (e.g., before a shift begins), the server 136 can select a set of tasks for each user 128 that results in the user 128 meeting or exceeding (subject to the constraints noted above) their respective targets.

At block 225, the server 136 is configured to select a transporter 130 to which the task definition from block 210 will be allocated. The selection at block 225 includes execution of an optimization process to minimize the travel distance and/or idle time for the transporters 130. For example, in the example shown in FIG. 4, the server 136 may select the transporter 130-1, as selecting the transporter 130-2 would lead to a longer period of idle time after the transporter 130-2 arrives at the task location 300, but before the user 128-3 arrives at the task location 300. In some examples, the performance of block 225 can be preceded by the selection of a subset of candidate transporters 130, similar to the selection of candidate users 128 set out above in connection with block 215.

In other examples, the selection of a transporter 130 at block 225 can be delayed until the user 128 selected at block 220 is within a certain distance or time of the task location 300. That is, in some examples the server 136 can select a user 128 at block 220, inform that user 128 of the task allocation via the corresponding device 134, and then delay the selection of a transporter 130 until the periodically updated location of the selected user 128 indicates that the user 128 will arrive at the task location 300 within, e.g., one minute (other time periods may also be used, however). The selection of a transporter 130 may therefore be simplified, e.g., by selecting the transporter 130 closest to the task location 300. Prior to selection of a transporter 130, the transporters 130 may therefore be allocated and complete other tasks.

In further examples, the selection of a transporter need not be delayed until the user 128 is within a certain time or distance of the task location 300. Instead, the selection of the transporter 130 can be completed prior to allocations being communicated to either the device 134 or the transporter 130, but the actual transmission of the task definition to the selected transporter 130 can be delayed until a certain time before arrival of the user 128 at the task location 300.

At block 235, the server 136 is configured to allocate the task definition to the user 128 selected at block 220, and to the transporter 130 selected at block 225. Allocation of the task includes, for example, sending a first message to the device 134 corresponding to the selected user 128, and sending a second message to the selected transporter 130. As noted above, the transmission of the first and second messages need not be simultaneous. In some examples, the first message may be transmitted before the selection of the transporter 130 (and therefore also precedes the transmission of the second message).

The messages sent at block 230 include at least the task location 300, and the item identifier 304 shown in FIG. 3. The messages can also include other information from the task definition, such as an item count or the like. In addition, the server 136 can supplement the data from the task definition with additional parameters derived from the selection processes and blocks 220 and/or 225. For example, each transporter 130 may include a number of distinct totes or other containers, and the server 136 can indicate in the first message (to the selected device 134) which tote the identified item should be placed.

Following allocation of the task to the selected user 128 and transporter 130 at block 230, the server 136 is configured to await confirmation that the task has been completed at block 235. For example, the devices 134 can be operated by the users 128 to generate confirmation messages upon transfer of the relevant item 108 to or from the relevant support structure 104, e.g., by scanning the item or receiving other suitable input data indicating that the transfer is complete. While the server 136 awaits such confirmation, other parallel instances of the method 200 can be performed to allocate further tasks.

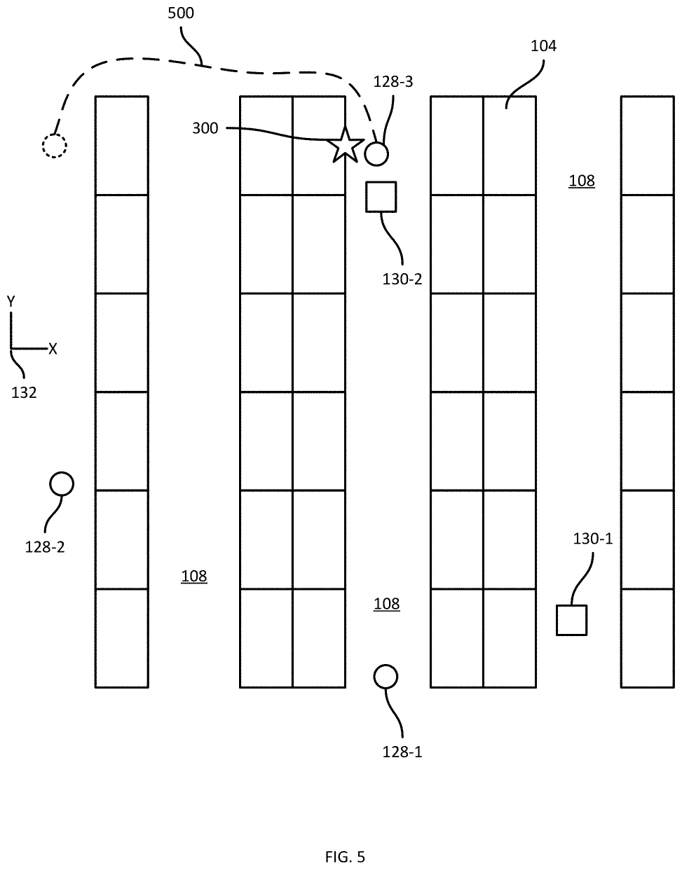

At block 240, following confirmation that the task has been completed, the server 136 is configured to update the user profile of the user 128 selected at block 220, in the repository 156. In particular, the server 136 can update the activity metric associated with the selected user 128, e.g., based on the locations received via repeated performances of block 205. In other examples, the device 134 of the selected user 128 (e.g., the device 134-3, in this example) can report updated activity metric data periodically, e.g., in the form of step counts, distance travelled, or the like. Turning to FIG. 5, for example, a path 500 illustrates the route taken by the user 128-3 towards the task location 300. The device 134-3 can collect step count data and/or other physical activity metrics, and report such metrics to the server 136 periodically, or upon completion of the task at the task location 300. The server 136 therefore updates the repository 156, e.g., as shown below in Table 2.

TABLE 2
Example Repository 156

| User ID | Device ID | Activity Target | Activity Metric |
|---|---|---|---|
| 128-1 | 134-1 | 5000 steps/day | 1400 steps |
| 128-2 | 134-2 | 2500 Cal./day | 1200 Cal. |
| 128-3 | 134-3 | 9000 steps/day | 2600 steps |

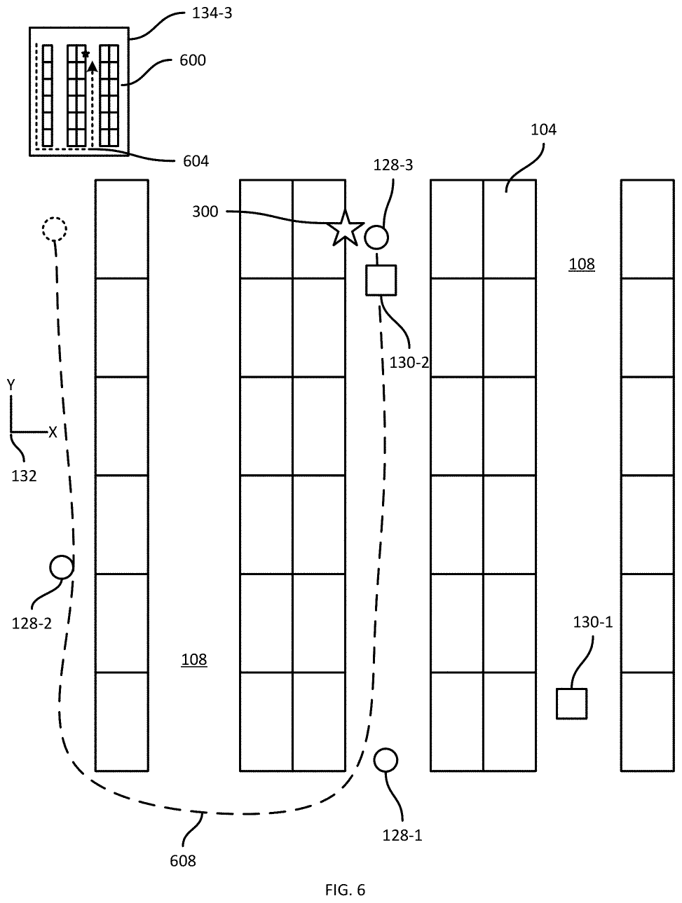

In other examples, the task allocation sent to the selected mobile device 134 at block 230 can include directional guidance, such as a map and/or a route to the task location 300 generated by the server 136. For example, referred to FIG. 6, the device 134-3 is illustrated, presenting a map 600 displaying a route 604 suggested to the user 128-3 by the server 136. FIG. 6 also illustrates a path 608 taken by the user 128-3 to the task location 300. In such examples, the server 136 can direct the travel of users 128 through the facility to exert greater control over the progress of the users 128 towards physical activity targets.

Returning to FIG. 2, at block 245 the server 136 can be configured to determine whether the activity targets of any users 128 have been met. When the determination at block 245 is negative, the server 136 can return to block 205 to continue monitoring device 134 and transporter 130 locations and allocating tasks. When the determination at block 245 is affirmative, however, the server 136 can be configured to automatically adjust the activity target(s) of any users 128 that have met their activity targets. For example, the server 136 can store an adjustment factor (e.g., specific to each user 128, or to be applied generally to any user 128). The adjustment factor can be a fraction (e.g., 5%) by which any met activity target is increased for a subsequent time period. Thus, for example, in response to the user 128-1 meeting the activity target of five thousand steps in one day, the server 136 can update the activity target of the user 128-1 to five thousand two hundred and fifty steps per day. The server 136 can also adjust targets downwards, e.g., by the adjustment factor, when the targets are not met.

Various other functions may also be performed by the server 136. For example, the server 136 can transmit messages to a device 134 in response to detection that a user 128 associated with the device 134 has reached an activity target. In other examples, the server 136 can automatically generate activity targets for certain users 128. For example, upon enrollment of a user 128, the server 136 can generate a default activity target for that user 128. In other examples, the repository 156 can contain additional records corresponding to groups of users 128. A group record can include a group activity target and corresponding metric, as well as identifiers of the member users 128 in the group. Because activity is tracked on a per-user basis, the server 136 can convert the group target into individual activity targets for each member user 128 (e.g., by dividing the group target by the number of member users 128). The group activity metric can be determined by summing the activity metrics of the member users 128.

The systems and methods set out above may provide certain technical advantages over other systems which assess container fullness on the basis of single, independent frames of data, e.g., by capturing one point cloud frame and assessing fullness based on a two-dimensional grid applied to the point cloud. Such systems may be unable to accurately track fullness under conditions such as those illustrated in FIG. 3, or any other conditions under which portions of a container become occluded. The assessment of container fullness based on current and historical data, as implemented by the systems and methods described herein, may enable increased fullness tracking accuracy even under those conditions.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A task allocation system, comprising:
a location tracking subsystem disposed in a facility, the facility containing a plurality of support structures, each support structure supporting items, the items having respective item identifiers;
a plurality of mobile computing devices, each of the plurality of mobile computing devices associated with a respective user in the facility;
a plurality of autonomous transporters deployed in the facility to at least one of (i) transport an item transferred by the user from one of the plurality of support structures, or (ii) transport the item to one of the plurality of the support structures to be transferred by the user thereto, the location tracking subsystem operable to obtain location data associated with each of the plurality of mobile computing devices and each of the plurality of autonomous transporters;
a user profile repository containing, for each of the users, a record defining (i) a physical activity metric, and (ii) a physical activity target; and
a server configured to:
obtain, from the location tracking subsystem, respective locations for each of the plurality of transporters and each of the plurality of mobile computing devices;
obtain a task definition containing (i) a task location, and (ii) an item identifier corresponding to an item to be transferred to or from one of the plurality of support structures at the task location;
select one of the plurality of transporters, according to the obtained transporter locations and the task location;
select one of the mobile computing devices, according to the obtained mobile computing device locations, the task location, the physical activity metrics, and the physical activity targets; and
allocate the task definition to the selected one of the transporters and the selected one of the mobile computing devices.

2. The task allocation system of claim 1, wherein the location tracking subsystem includes at least one of (i) a radio frequency identification (RFID) reader, (ii) a wireless access point, and (iii) a wireless beacon emitter.

3. The task allocation system of claim 1, wherein the server is configured, to allocate the task definition, to generate a first message to the selected transporter, and a second message to the selected mobile computing device, each of the first and second messages containing the task location and the item identifier.

4. The task allocation system of claim 1, wherein the server is configured, to select the one of the mobile computing devices, to execute an optimization process to reduce a difference between the physical activity metrics and the physical activity targets.

5. The task allocation system of claim 1, wherein the server is configured, to select the one of the transporters, to execute an optimization process to reduce at least one of (i) travel distance for the transporters, or (ii) idle time.

6. The task allocation system of claim 1, wherein the server is further configured to update the physical activity metrics according to the obtained mobile computing device locations.

7. The task allocation system of claim 1, wherein the server is configured, to select the one of the mobile computing devices, to:
identify a subset of the mobile computing devices that are within a threshold distance of the task location; and
select the one of the mobile computing devices from the subset.

8. The task allocation system of claim 7, wherein the threshold distance is derived from a task completion time limit maintained at the server.

9. The task allocation system of claim 1, wherein the server is further configured, prior to obtaining the locations of the mobile computing devices, to:
automatically generate the physical activity target for at least one of the workers.

10. The task allocation system of claim 1, wherein the server is further configured to adjust at least one of the physical activity metrics in response to the at least one activity metric meeting a corresponding one of the physical activity targets.

11. A method, comprising:
obtaining, from a location tracking subsystem disposed in a facility, the facility containing a plurality of support structures, each support structure supporting items, the items having respective item identifiers, respective locations for each of a plurality of transporters and each of a plurality of mobile computing devices, wherein (a) each of the plurality of mobile computing devices is associated with a respective user in the facility, and (b) each of the plurality of autonomous transporters is deployed in the facility to at least one of (i) transport an item transferred by the user from one of the plurality of support structures, or (ii) transport the item to one of the plurality of the support structures to be transferred by the user thereto;
obtaining a task definition containing (i) a task location, and (ii) an item identifier corresponding to an item to be transferred to or from one of the plurality of support structures at the task location;
select one of the plurality of transporters, according to the obtained transporter locations and the task location;
selecting one of the mobile computing devices, according to the obtained mobile computing device locations, the task location, physical activity metrics for each of the users, and physical activity targets for each of the users, wherein the physical activity metrics and the physical activity targets are stored in a user profile repository; and
allocating the task definition to the selected one of the transporters and the selected one of the mobile computing devices.

12. The method of claim 11, wherein allocating the task definition includes:
generating a first message to the selected transporter, and generating a second message to the selected mobile computing device, each of the first and second messages containing the task location and the item identifier.

13. The method of claim 11, wherein selecting the one of the mobile computing devices includes executing an optimization process to reduce a difference between the physical activity metrics and the physical activity targets.

14. The method of claim 11, wherein selecting the one of the transporters includes executing an optimization process to reduce at least one of (i) travel distance for the transporters, or (ii) idle time.

15. The method of claim 11, further comprising: updating the physical activity metrics according to the obtained mobile computing device locations.

16. The method of claim 11, wherein selecting the one of the mobile computing devices includes:
identifying a subset of the mobile computing devices that are within a threshold distance of the task location; and
selecting the one of the mobile computing devices from the subset.

17. The method of claim 16, wherein the threshold distance is derived from a task completion time limit maintained at the server.

18. The method of claim 11, further comprising, prior to obtaining the locations of the mobile computing devices:
automatically generating the physical activity target for at least one of the workers.

19. The method of claim 11, further comprising adjusting at least one of the physical activity metrics in response to the at least one activity metric meeting a corresponding one of the physical activity targets.

20. A task allocation system, comprising:
a location tracking subsystem disposed in a facility, the facility containing a plurality of support structures, each support structure supporting items, the items having respective item identifiers;
a mobile computing device associated with a user in the facility;
an autonomous transporter deployed in the facility to at least one of (i) transport an item transferred by the user from one of the plurality of support structures, or (ii) transport the item to one of the plurality of the support structures to be transferred by the user thereto, the location tracking subsystem operable to obtain location data associated with the mobile computing device and the autonomous transporter;
a user profile repository containing, for the user, a record defining (i) a physical activity metric, and (ii) a physical activity target; and
a server configured to:
obtain, from the location tracking subsystem, respective locations for the transporter and the mobile computing device;
obtain a task definition containing (i) a task location, and (ii) an item identifier corresponding to an item to be transferred to or from one of the plurality of support structures at the task location;
allocate the task definition to the transporter according to the obtained transporter location and the task location; and
allocate the task definition to the mobile computing device, according to the obtained mobile computing device location, the task location, the physical activity metric, and the physical activity target.
